(19) United States
(12) Patent Application Publication
(10) Pub. No.: US 2026/0185555 A1
(43) Pub. Date: Jul. 2, 2026

(54) IMPROVED DIFFERENTIAL SHAFT

(71) Applicant: HYDROMECANIQUE ET FROTTEMENT, ANDREZIEUX-BOUTHEON (FR)

(72) Inventors: Christophe HEAU, SAINT-JEAN-BONNEFONDS (FR); Etienne MACRON, ST MARCELLIN EN FOREZ (FR)

(21) Appl. No.: 19/130,942

(22) PCT Filed: Sep. 19, 2023
(86) PCT No.: PCT/FR2023/051426

§ 371 Date: May 16, 2025

(30) Foreign Application Priority Data
Nov. 17, 2022 (FR) FR2211978

(51) Int. Cl. F16C 3/02; F16H 48/08; F16H 48/38

(52) U.S. Cl. CPC F16C 3/02; F16H 48/38; F16C 2202/02; F16C 2220/60; F16C 2223/06; F16C 2223/60; F16C 2326/20; F16C 2361/61; F16H 2048/085; F16H 2048/382

(57) ABSTRACT

The invention relates to a differential shaft (1) composed of a substrate having at least one flat surface (20) and comprising a coating layer deposited on the substrate. According to the invention, the machining of the flat surface (20) defines edges (21) bordering a bearing surface (11) of the substrate, and the edges (21) have a rounding having a radius greater than or equal to 0.05 mm.

### DESCRIPTION

### Technical Field

The invention relates to the technical field of motor vehicles, in particular to the differential shafts provided in vehicles.

### Prior Art

In vehicles, a differential allows wheels on the same axle to rotate at different speeds during cornering. A differential comprises a shaft mounted pivotally with respect to differential pinions, each of which meshes with a differential side gear rigidly connected to the driven shafts of the axle.

When the vehicle takes a corner, the differential side gears rotate at different speeds, and the differential pinions rotate freely about the shaft of the differential, which therefore experiences significant friction when the vehicle is in use; it is a part that is particularly subject to wear.

To compensate for the wear on the differential shaft or the counterpart differential pinion, it is known to provide on the shaft flat surfaces for moving oil as far as to the interface between the differential shaft and the pinion.

It is also known to deposit anti-friction coatings on the outer surface of the differential shaft. These anti-friction coatings are intended to reduce wear on the shaft and the counterpart pinion.

Document WO201511361, in the name of the applicant, discloses depositing an anti-friction coating of this kind. However, anti-friction coatings are not always compatible with use on a differential shaft as they may have a tendency to flake. This phenomenon is observed particularly in the case of differential shafts having a flat surface.

In addition, with the emergence of electric vehicles, the conditions of use for vehicle gearings are changing significantly. Electric motors behave very differently from thermal engines-the nominal torque of an electric motor is reached at very low motor speeds. The dynamic stress on the parts is therefore increased, and the differential shafts degrade more quickly.

### SUMMARY OF THE INVENTION

The aim of the invention is therefore to propose an improved differential shaft that remedies the disadvantages of the prior art and for which the resistance of a coating layer to degrading is enhanced.

In this regard, a differential shaft has been developed, composed of a substrate having at least one machining of a flat surface and comprising a coating layer deposited on the substrate.

According to the invention, the machining of the flat surface defines edges bordering a bearing surface of the substrate, and the edges have a rounding having a radius greater than or equal to 0.05 mm and preferably less than 5 mm. Preferably, the rounding is tangential.

This optimises the geometry of the differential shaft so as not to have sharp edges, which would encourage flaking of the deposited coating.

The proposed solution is simple and inexpensive because implementing it requires only known, proven means and avoids complex improvements that could have been sought, for example concerning the chemistry or the method of depositing the coating.

Advantageously, and still with the aim of reducing the concentrations of stresses that may occur at the edges, the radius is greater than 0.1 mm, preferably greater than 0.5 mm, even more preferably greater than 1 mm or even greater than 1.5 mm.

In one configuration, the coating layer comprises DLC-type amorphous carbon. This type of coating is tried and tested and produces good results in terms of coefficient of friction and resistance to wear.

The invention also relates to a method for producing a differential shaft, comprising the following steps:
obtaining a cylindrical substrate;
machining a flat surface;
depositing a coating layer on the substrate.

According to the invention, the method comprises a step of grooving an edge defined by the machining of the flat surface, prior to the depositing step.

This method makes it possible to obtain a differential shaft having the aforementioned advantages, with the grooving step providing the desired rounding.

To promote the adhesion of the coating deposited on the substrate, the method comprises a first step of polishing the substrate prior to the depositing step. This method also imparts better cohesion on the materials forming the deposited coating.

Advantageously, the first polishing step involves obtaining a roughness Ra of less than 0.1 μm.

To reduce roughness peaks generated during the depositing step, the method comprises a second step of polishing the coating layer after the depositing step. If the coating peaks are torn off while the shaft is in use, this could produce abrasive particles that speed up the deterioration of the shaft.

Advantageously, the grooving step and/or the first polishing step and/or the second polishing step is/are carried out by means of a centreless grinding wheel or a vibrating bowl. Both of these polishing methods are simple to implement.

To be able to parameterise the deposition of the coating layer in a simple manner, the coating layer is deposited by physical vapour deposition, preferably plasma-enhanced.

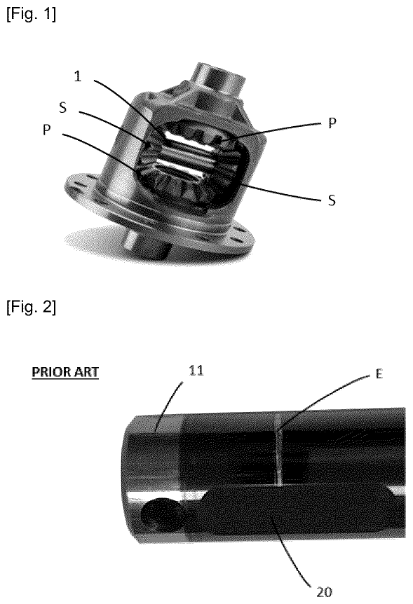

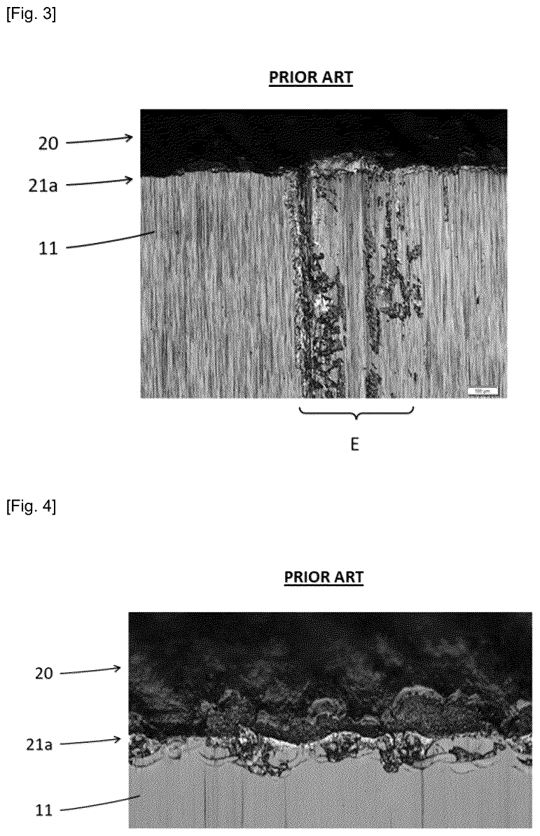

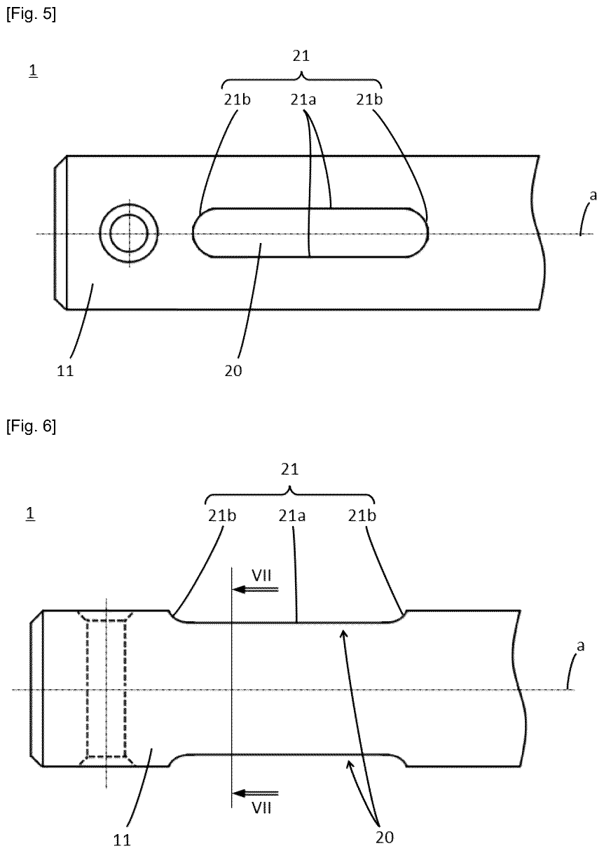

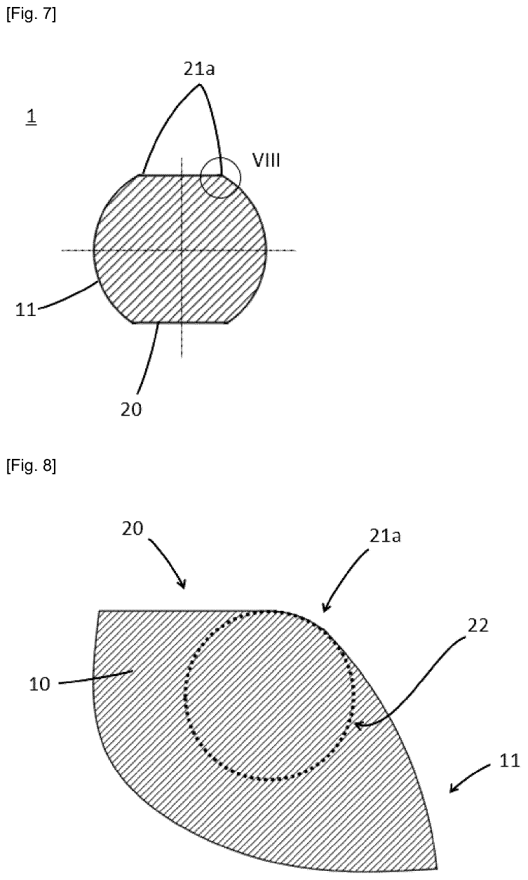

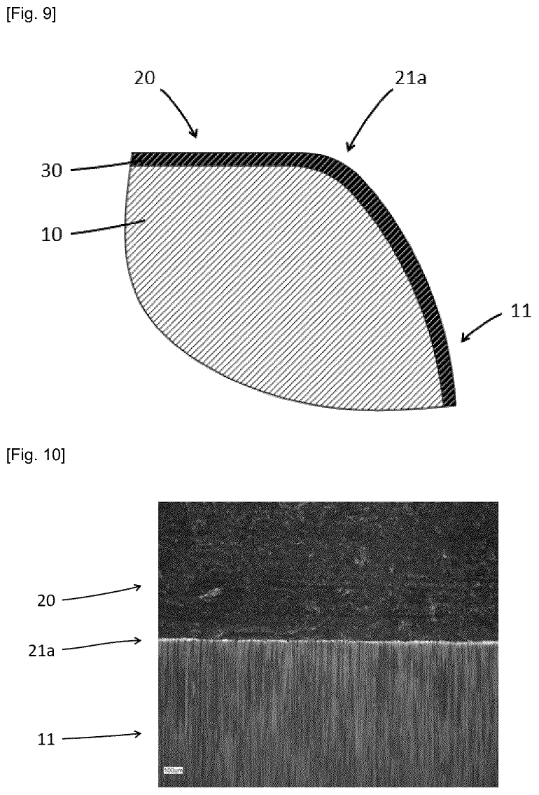

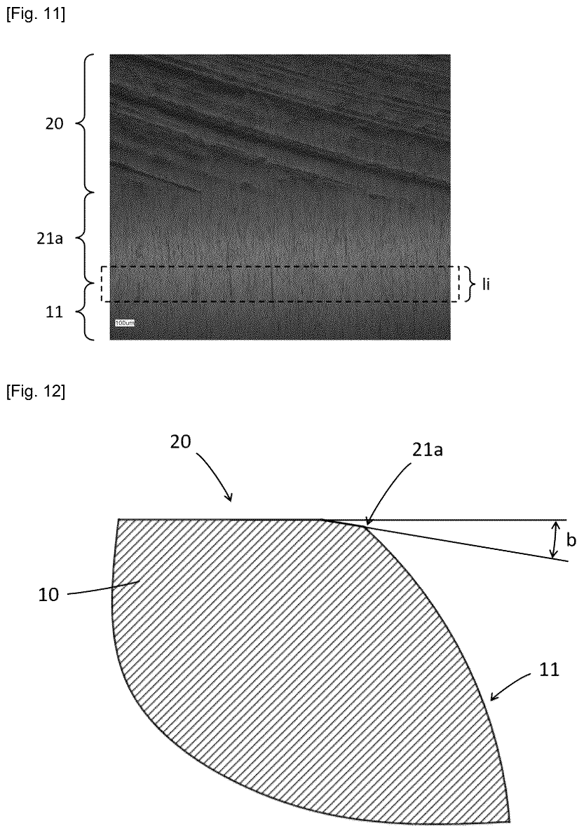

### BRIEF DESCRIPTION OF THE DRAWINGS

[FIG. 1] shows a vehicle differential on which a differential shaft, differential pinions and differential side gears are visible.

[FIG. 2] shows a prior-art differential shaft in a degraded state.

[FIG. 3] is an illustration of an enlargement of the degraded region of the shaft in FIG. 2.

[FIG. 4] is another illustration of the enlargement of the degraded region of the shaft in FIG. 2.

[FIG. 5] is a plan view of a shaft according to the invention that has not yet received an anti-friction coating.

[FIG. 6] is a front view of this shaft.

[FIG. 7] is a section through this same shaft from the side.

[FIG. 8] shows an enlargement of the section in FIG. 7.

[FIG. 9] shows a similar section to that in FIG. 8, showing a shaft according to the invention that has received the anti-friction coating.

[FIG. 10] is an illustration of an enlargement of the interface between a flat surface and a bearing surface of a differential shaft before the rounding is produced.

[FIG. 11] is an illustration of an enlargement of the interface between a flat surface and a bearing surface of a differential shaft after the rounding has been produced by polishing.

[FIG. 12] shows a similar section to that of FIG. 8, showing a shaft according to the invention further having a chamfer between the flat surface and the bearing surface before the rounding is produced.

### DETAILED DESCRIPTION OF THE INVENTION

With reference to FIG. 1, the invention relates to a shaft (1) for a vehicle differential. It is noted that the shaft (1) of the differential, which bears the two differential pinions(S), is subject to frequent degradation.

FIG. 2 shows a prior-art differential shaft (1) on which a flat surface (20) is provided in order to place an oil tank in communication with a friction surface between the cylindrical bearing surface (11) of the shaft (1) and the bore in the differential pinion (S). The shaft (1) is coated with an anti-friction coating (30), such as a deposit of DLC-type amorphous carbon.

It can be seen in this figure that the shaft (1) is degraded; the coating (30) has been torn off in the region of a scratch (E).

With reference to FIGS. 3 and 4, it can be seen that material has torn off in the region of the edge (21) bordering the flat surface (20). These observations led the applicant to investigate the nature and behaviour of the coating (30) in the vicinity of the edge (21).

It seems that the machining of the flat surface (20) defines a sharp edge (21) at the juncture with the cylindrical bearing surface (11) of the shaft (1) and that the flaking of the coating (30), and thus the rapid degradation of the shaft (1), is promoted by the sharpness of the edge (21).

In addition, the scratches produced during the machining of the flat surface (20) exacerbate this phenomenon.

With reference to FIGS. 5 to 12, the main crux of the invention is that the sharp edge (21) generated during the machining of the flat surface (20) is rounded. Measuring the machining scratches and the facies of the material tears gives values between 50 μm and 100 μm. The rounding therefore has to be at least 0.05 mm. In this way, the edge (21) no longer exhibits incipient flaking from the substrate (10).

Depending on the roughness of the substrate (10) forming the differential shaft (1), the rounding may have a higher value, for example 0.1 mm, 0.25 mm, 0.3 mm, 0.5 mm or even more than 1 mm; the larger the rounding, the more it will be able to compensate for the local defects corresponding to a significant roughness.

Opting for a rounding radius of at least 0.1 mm rules out degradation that could originate from machining scratches. Opting for a rounding radius of at least 0.25 mm or 0.3 mm can guarantee a safety factor against such degradation.

In practice, the upper limit of the value of the rounding is not essential; one dedicated portion should merely be retained for the oil to travel between the shaft (1) and the bore in the pinion(S). Good results have been obtained with roundings of 1.3 mm or 2.2 mm.

In the case of a rounding obtained by polishing, a higher value goes hand in hand with longer polishing; therefore, a balance has to be struck between the surface state of the substrate (10) after the machining of the flat surface (20) and the desired radius.

It may be necessary to polish the part in one direction of rotation about its axis (a) and then in the opposite direction of rotation in order to polish the two edges in the same way, especially when the polishing is done using belts and/or grinding wheels.

When a rounding is obtained by CNC machining (computer numerical control), the difficulty related to this balance is lessened.

It is also possible to polish the substrate (10) in order to adjust its surface state before the coating (30) is deposited. In particular:
the arithmetic roughness Ra of the substrate (10) may be less than or equal to 0.1 μm, preferably less than 0.07 μm, even more preferably less than 0.04 μm;
the maximum roughness Rz may be less than or equal to 0.1 μm, preferably less than or equal to 0.08 μm, even more preferably less than 0.04 μm;
the reduced depth of the peaks Rpk may be less than or equal to 0.07 μm, preferably less than or equal to 0.05 μm.

The different roughness measurements are indirectly correlated with each other in so far as polishing reduces all the roughness values; however, the different measurement methods do not reflect the same features of the surface:
The arithmetic roughness Ra reflects the average roughness of the substrate. It is not significantly influenced by scuffing or contamination.
The maximum roughness Rz reflects the maximum amplitude between the peaks and troughs on the surface. It is very sensitive to scuffing and also to contamination due to its dependence on the peak values.
The reduced depth of the peaks Rpk reflects the presence of local peaks that are liable to be torn off during an initial phase of use of the shaft (1); this would generate abrasive particles at the interface. This value is suitable for assessing friction and abrasion.

Producing the rounding by polishing therefore makes it possible to obtain the following in a single step:
a suitable roughness of the substrate (10) for the deposit to properly adhere to the substrate (10); and
a sufficient rounding of the edge (21) to avoid the phenomena of material flaking or tearing.

With reference more particularly to FIG. 5, the edge (21) defined by the flat surface (20) comprises two rectilinear portions (21a) parallel to the rotational axis (a) of the differential shaft (1), and two elliptical portions (21b). The rounding has to be present at the interface with the bores in the pinions (S); in general, this concerns the rectilinear portions (21a), and the rounding is also preferably present at least on the rectilinear portions (21a).

FIG. 10 shows a longitudinal edge (21a) of this kind before the rounding is produced.

With reference to FIG. 12, the machining of the flat surface (20) may have a chamfer, of angle (b). It should be noted that the part of the shaft (1) where the degradation occurs during use is the interface with the bore in the pinion (S); in all cases, the edge (21a) is the line of intersection between the machining (flat surface (20) or chamfer) and the bearing surface (11) of the shaft (1).

In practice, polishing means, such as a centreless grinding wheel or a vibrating bowl, polish the entire periphery of the edge (21) and thus provide the desired rounding around the entire periphery of the edge (21). Centreless grinding wheels have a certain flexibility, allowing them to embrace the entire periphery of the edge (21) during polishing. The same applies to polishing carried out using abrasive belts.

With reference to FIG. 11, the rounded edge (21a) makes it possible to obtain a gradual transition from the bearing surface (11) towards the flat surface (20).

Thus, concentrations of stresses are avoided within the coating material. An effect whereby the bore in the pinion(S) is machined by the edge (21a) is also avoided.

The boundary of the interface (li) between the shaft (1) and the bore in the pinion (S) is at the tangency between the rounding of the edge (21a) and the bearing surface (11). It can also be seen in this figure that machining scratches present on the flat surface (20) are now set back from the boundary of the interface (li); there is no longer any risk of tearing or flaking due to the geometry or the roughness of the scratches.

FIG. 8 is a section through a substrate (10) of a shaft (1) prior to the depositing step. The rounding according to the invention can be seen therein. In this figure, the rounding is tangential in order to reduce incipient fractures as much as possible.

The radius of the rounding can be measured by profilometry by reconstructing a circle (22) passing through the measured points of the rounding.

FIG. 9 shows a shaft (1) according to the invention. The coating layer (30) is deposited on the substrate (10), preferably by means of vacuum vapour deposition, optionally plasma-enhanced. This method makes it easy to adjust the chemistry of the deposited material by selecting a suitable target and/or suitable precursor gases. Moreover, adjusting the depositing and enhancement parameters allows the nature of the deposited layer to be modified.

The coating layer (30) preferably comprises DLC-type amorphous carbon, but other coatings such as nickel electroplating may be envisaged. However, the advantage of DLC is that it is more resistant to wear than other coatings.

The coating layer (30) is generally a few micrometres thick, typically between 0.5 μm and 5 μm. Thus, even on a finished shaft (1), it is possible to estimate with sufficient accuracy the rounding that the substrate (10) had before the coating step, when the radius of the edge (21) is measured by profilometry.

The shaft (1) and its production method may be designed differently from the examples given, without departing from the scope of the invention as defined by the claims.

The rounding may have a different value on different portions of the edge (21) of the shaft. For example, a longitudinal edge (21a) on the left-hand side of the flat surface (20) may have a rounding of 1.9 mm, while the longitudinal edge (21 a) on the right-hand side of the same flat surface (20) may have a rounding of 1.5 mm.

Furthermore, the technical features of the various embodiments and variants mentioned above can be combined in their entirety or only in part. Thus, the shaft (1) and its production method can be adapted in terms of costs, functionalities and performance.

1. A differential shaft composed of a substrate having at least one machining of a flat surface and comprising a coating layer deposited on the substrate, wherein the machining of the flat surface defines edges bordering a bearing surface of the substrate, and the edges have a rounding having a radius greater than or equal to 0.05 mm

2. The differential shaft according to claim 1, wherein the radius is greater than 0.1 mm,

3. The differential shaft according to claim 1, characterised in that the coating layer comprises DLC-type amorphous carbon.

4. A method for producing a differential shaft, comprising the following steps:
obtaining a cylindrical substrate;
machining a flat surface;
depositing a coating layer on the substrate;
wherein said method comprises a step of grooving an edge defined by the machining of the flat surface, prior to the depositing step.

5. The method according to claim 4, wherein the grooving involves obtaining a rounding having a radius greater than 0.05 mm.

6. The method according to claim 4, wherein the method comprises a first step of polishing the substrate prior to the depositing step.

7. The method according to claim 6, wherein the first polishing step involves obtaining a roughness Ra of less than 0.1 μm.

8. The method according to claim 4, wherein the method comprises a second step of polishing the coating layer after the depositing step.

9. The method according to claim 4, wherein the grooving step is carried out by means of a centreless grinding wheel or a vibrating bowl.

10. The method according to claim 1, wherein the coating layer is deposited by physical vapour deposition.

11. The method according to claim 6, wherein the first polishing step is carried out by means of a centreless grinding wheel or a vibrating bowl.

12. The method according to claim 8, wherein the second polishing step is carried out by means of a centreless grinding wheel or a vibrating bowl.
